(19) United States
(12) Patent Application Publication
(10) Pub. No.: US 2004/0068519 A1
(43) Pub. Date: Apr. 8, 2004

(54) System, method and computer program product for facilitating performance of an action at one or more target locations

(76) Inventors: Kenneth L. Smukler, Villanova, PA (US); Timothy E. Dickson, Alexandria, VA (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/266,173

(22) Filed: Oct. 7, 2002

(51) Int. Cl. G06F 7/00

(52) U.S. Cl. 707/104.1

(57) ABSTRACT

A system is provided for facilitating performance of an action (e.g., voting) at one or more target locations (e.g., polling location). The system includes a processing element capable of receiving location messages reciting target locations. The processing element can associate each location message with one or more recipient contact identifiers based upon the target location recited by the respective location message, where the recipient contact identifiers are associated with one or more recipients. The processing element can also create one or more deliverable messages based upon the location messages and an action facilitating message, where the action facilitating message recites the action to be performed and where the deliverable messages are associated with the recipient contact identifiers associated with the location messages. The processing element can deliver the deliverable messages to recipients based upon the respective recipient contact identifier to thereby facilitate the recipients performing the action at the target locations.

### FIELD OF THE INVENTION

The present invention relates to systems and methods of facilitating performance of an action and, more particularly, relates to systems, methods and computer program products for facilitating performance of an action at at least one target location.

### BACKGROUND OF THE INVENTION

Everyday consumers are solicited by advertisers to perform desired actions. In one of the most common examples, consumers are routinely solicited to purchase certain goods or services through print, television, radio, telemarketing and/or advertisements. In another example, voters in political elections receive print, television, radio, telemarketing and/or electronic advertisements touting the qualifications or positions of political candidates in an attempt to persuade consumers to vote for the respective candidates (or not vote for an opposing candidate) in an upcoming election. Typically, advertisements are disseminated to consumers and voters without regard to the type of consumer or voter receiving the advertisements. Typically, many advertisements then are inefficiently disseminated to consumers and voters. For example, presume a manufacturer of woman's clothes desires to persuade women to purchase the manufacturer's clothes. As males will not likely be persuaded by the advertising into purchasing the manufacturer's clothes, most advertising the manufacturer disseminates that is received by males can be considered inefficient use of advertising.

In an attempt to increase the efficiency of advertising, many advertisers have begun to utilize targeted advertising whereby the advertiser seeks to focus dissemination of their advertising to those consumers or voters most likely to be persuaded by the advertising into performing the desired action. In this regard, advertisers engaged in targeted advertising typically utilize some form of consumer or voter profile information regarding the type of consumer or voter most likely to be persuaded by the advertisement, such as, for example, age, sex, affluence, ethnicity, geographic area and/or political party. Using the profile information, then, the advertiser can focus their advertising efforts to those consumers or voters that provide the closest match with the type of consumer or voter identified by the profile information. In the above example, then, the manufacturer could utilize voter profile information to advertise in those publications most frequently viewed by females.

Whereas conventional targeted advertising adequately increases the likelihood that the consumers or voters will perform the desired action, such advertising has drawbacks. In this regard, many conventional advertisements attempt to tell consumers or voters what action to perform, but typically do not tell the same consumers or voters where to perform the action. For example, many conventional advertisements attempt to persuade consumers into purchasing certain goods or services, but do not inform the same consumers as to where the consumers can purchase the advertised goods or services. Also, for example, many conventional political advertisements attempt to persuade voters into voting for a particular political candidate, but do not inform the same voters as to where the voters can vote for the candidate. Thus, some consumers and/or voters who may have been persuaded by the advertisement, may nonetheless fail to perform the desired action as such consumers and/or voters may not know how to find out a location at which to perform the desired action, or may not want to take the time required to find out the location.

It will be appreciated that some advertisements do indicate a general location at which to perform the desired action. However, just as in the case of non-targeted advertising, such general location indications can be inefficient use of advertising. In this regard, presume an advertisement indicates to a consumer that a particular good can be purchased at a particular chain of retail stores. Many such advertisements do not separately list the specific location of each store or only list a select few locations, particularly in national advertisements. As such, consumers not familiar with the location of one such retail store will typically not have enough information as to the location at which the consumer can purchase the good. Thus, even if such consumers are persuaded by the advertisement to purchase the good, the consumer may not desire to take the time to find out the location of one of the retail stores and, thus, may not end up purchasing the good.

### SUMMARY OF THE INVENTION

In light of the foregoing background, the present invention provides a system, method and computer program product for facilitating performance of an action at at least one target location. For example, the system, method and computer program product of embodiments of the present invention can facilitate recipients purchasing a particular good or service at a retail store, preferably a retail store located a short distance from respective recipients. In another example, the system, method and computer program product of embodiments of the present invention can facilitate voters voting for a particular political candidate at a polling location, such as a polling location located in a precinct within which respective voters live. And in yet another example, the system, method and computer program product of embodiments of the present invention can facilitate seeking shelter or assistance from local police, firefighters and/or medical personnel located at police stations, fire stations and/or hospitals.

The system, method and computer program product of embodiments of the present invention are capable of providing messages to targeted recipients based upon information relative to the recipients. In this regard, the system, method and computer program product of embodiments of the present invention are capable of providing the advantages of conventional targeted advertising. In contrast to conventional targeted advertising, however, the system, method and computer program product of embodiments of the present invention further facilitate performance of an action (e.g., voting) by providing a target location at which the recipient can perform the action (e.g., polling location). As such, the system, method and computer program product of embodiments of the present invention are capable of facilitating recipients performing the action, where the recipients are persuaded by the message to perform the action but otherwise do not know of a convenient location to perform the action or do not want to take the time to discover a convenient location. Therefore, the system, method and computer program product of embodiments of the present invention solve the problems identified by prior techniques and provide additional advantages.

According to one aspect of the present invention, a system is provided for facilitating performance of an action (e.g., voting) at one or more target locations (e.g., polling location). The system includes a processing element capable of receiving one or more location messages (e.g., sound recordings) reciting the target locations. In one embodiment, the processing element can receive the target locations and thereafter create the location messages based upon the target locations.

After receiving or creating the target messages, the processing element can associate each location message with one or more recipients based upon recipient specific information (e.g., telephone numbers) and the target location recited by the respective location message. The recipient specific information can identify one or more recipients at one or more recipient locations. In this regard, processing element can be capable of associating each location message with the recipients based upon the target location recited by the respective location message and the recipient locations. Additionally, the processing element can associate at least one action facilitating message reciting additional information with at least one recipient based upon recipient specific information. In one embodiment, the processing element can select at least one recipient from a group of recipients. In such an embodiment, the processing element can associate each location message with the selected recipients.

The processing element can also create one or more deliverable messages (e.g., sound recordings) based upon the location messages and one or more action facilitating messages (e.g., sound recordings), where at least one of the action facilitating messages recites the action to be performed. Like the location messages, the deliverable messages are associated with the recipients associated with the location messages. In embodiments where the processing element associates action facilitating messages reciting additional information with recipients, the processing element can create the deliverable messages based upon the location messages, the action facilitating messages reciting the action to be performed and the action facilitating messages reciting additional information. In addition to the processing element, then, the system includes at least one database in electrical communication with the processing element. The databases are capable of storing the location messages, the recipient specific information, the deliverable messages, and/or the action facilitating message.

With the deliverable messages then, the processing element is capable of delivering the deliverable messages to the respective recipients to thereby facilitate the recipients performing the action at the target locations. For example, when the recipient specific information comprises recipient specific telephone numbers, the processing element can deliver the deliverable messages by calling each recipient based upon a respective telephone number and thereafter deliver a respective deliverable message. In embodiments where the deliverable messages comprise sound recordings, the processing element can deliver the deliverable sound recordings by calling each recipient based upon a respective telephone number and thereafter playing a respective deliverable sound recording. In embodiments where the processing element has selected recipients from a group of recipients, the processing element can deliver the deliverable messages to the respective selected recipients. And in another embodiment, the processing element is capable of gathering data regarding delivery of the deliverable messages before, during and/or after delivery of the deliverable messages.

In one particularly advantageous embodiment, the system facilitates performance of the action at one of plurality of target locations. In this embodiment, the processing element is capable of receiving a plurality of location messages each reciting a different target location. The processing element can then associate each of the plurality of location messages with at least one recipient, where each location message recites a different target location. In this regard, the processing element can create a plurality of deliverable messages based upon the plurality of location messages and at least one action facilitating message, and thereafter deliver each of the plurality of deliverable messages to the recipients associated with the respective deliverable message.

A method and computer program product for facilitating performance of an action at at least one target location are also provided. Therefore, the system, method and computer program product of embodiments of the present invention are capable of providing messages to targeted recipients based upon recipient specific information, such as contact information. In this regard, the system, method and computer program product of embodiments of the present invention provide the advantages of conventional targeted advertising over mass advertising. Advantageously, and in contrast to conventional targeted advertising, the system, method and computer program product of embodiments of the present invention further facilitate performance of an action (e.g., voting) by providing a target location at which the recipient can perform the action (e.g., polling location). As such, embodiments of the present invention are capable of facilitating recipients performing the action where the recipients are persuaded by the message to perform the action but otherwise do not know of a convenient location to perform the action.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a system for facilitating performance of an action at at least one target location according to one embodiment of the present invention; and

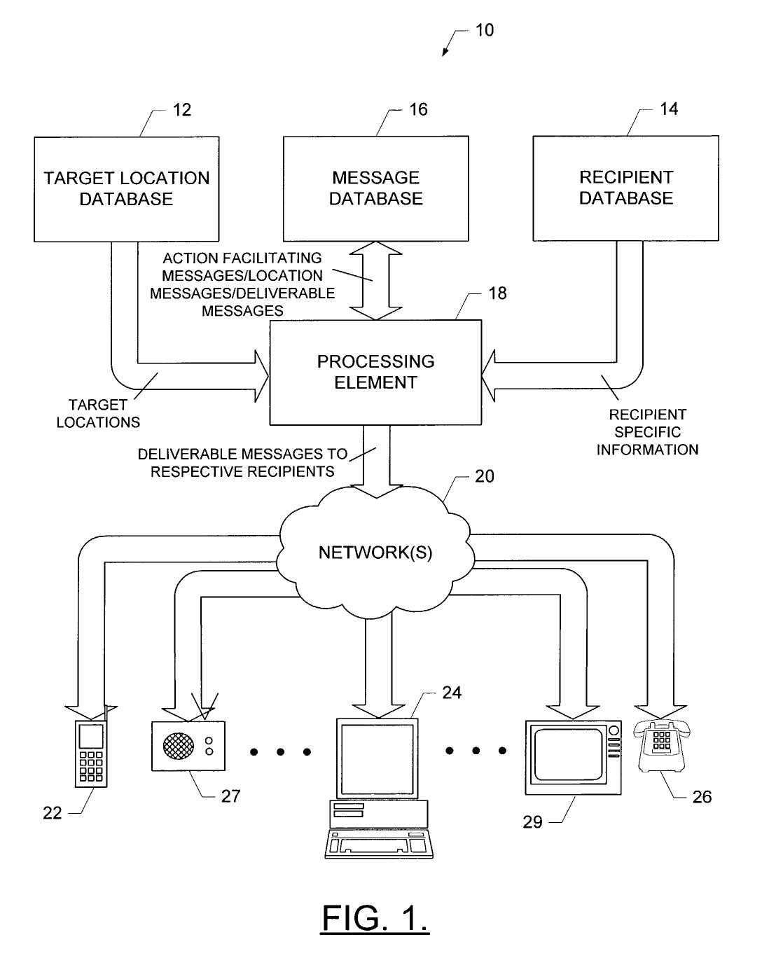

FIG. 2 is a flow chart illustrating various steps in a method of facilitating performance of an action at at least one target location according to one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Embodiments of the system, method and computer program product of the present invention that facilitate performance of an action at at least one target location are provided, according to one embodiment of the present invention. The system can facilitate performance of any one of a number of different actions at any one of a number of different locations. For example, the system can facilitate purchasing a particular good or service at any one of a number of different locations that offer the good for sale. As another example, the system can facilitate voting for a particular political candidate in a political election, where voting takes place at any one of a number of polling locations. As yet a further example, the system can facilitate seeking shelter or assistance from local police, firefighters and/or hospitals where the shelter or assistance is to be received at the local police station, fire station, hospital or other location.

The system can facilitate performance of the action by delivering to a number of recipients a deliverable message, such as a targeted advertisement, that contains one or more action facilitating messages and a location message. One of the action facilitating messages, which can be general to all the recipients or a select group of recipients, recites the action to be performed, such as purchasing a particular good or service, or voting for a particular political candidate. Other of the action facilitating messages, then, can provide additional information in attempting to persuade a recipient to perform the recited action, such as a particular discount on the purchase of a good. The location message, then, recites one or more target locations where the action can be performed, such as a retail store, a polling location, or a uniform resource locator (URL) for an online location. Advantageously, the location message is specific to one or more recipients, such as by reciting one or more locations located a close distance from respective recipients or a location frequented by those with characteristics similar to respective recipients. As such, not only can the deliverable messages deliver an action facilitating message attempting to persuade the recipient in performing the action, but the deliverable messages can also deliver a location message informing the recipients of a convenient location at which the recipients can perform the action.

According to one embodiment, the system includes a location database 12 capable of storing information relative to the target locations, a recipient database 14 capable of storing recipient specific information, and a message database capable of storing messages (or portions thereof) capable of being delivered to the recipients. The databases can comprise any of a number of different known electronic databases capable of storing electronic information, data or the like. It will be appreciated, then, that whereas the location database, the recipient database and the message database are shown and described as comprising separate databases, the information stored in two or more of the databases can be embodied in a single database without departing from the spirit and scope of the present invention. Alternatively, one or more databases can individually comprise more than one database capable of storing the respective information. For example, the message database can comprise three databases with one database capable of storing the messages to be delivered to the recipients (deliverable messages as described below), and the other databases capable of storing portions of the messages to be delivered (action facilitating message and location messages as described below).

More particularly as to each database, the location database 12 can store any of a number of different types of information relative to the target locations, such as operational information, location information and/or profile information. The target locations can comprise any of a number of different addressable locations, such as a physical location addressable by a postal address and/or an online location addressable by a uniform resource locator (URL). For example, the location database can store operational information such as a name of the target location, hours of operation and/or a telephone number. Regarding the location information, the location database can store a precise location associated with the respective target location, such as the physical address and/or URL. Additionally, or alternatively, the location information stored by the location database can include a more general location associated with the respective target location. For example, each target location can be associated with location information based upon the physical location of the respective target location relative to one or more particular physical regions of varying area. Additionally, or alternatively, each target location can be associated with location information based upon one or more particular physical regions of varying area serviced by the respective target location, particularly when the target location comprises an online location.

The more general location information for each target location stored in the target location database 12 can include one or more geo-codes comprising the general location associated with the respective target defined relative to one or more regions of varying area. For example, in instances in which the target locations comprise polling locations, each target location can include geo-codes defining the general location of the target location based upon the location of the target location within a division or precinct, a county, a state and/or a country. Also, for example, in instances in which the target locations comprise URL's of online counterparts to stores of a chain of stores each servicing particular regions, each target location can include geo-codes defining the region serviced by the online counterparts. In this regard, consider a nationwide financial institution comprising a chain of branches. Due to different banking laws and regulations in different states, such a financial institution may have a different online location for branches located in each state. In this regard, visitors to the online counterpart of the financial institution can receive information tailored to the state in which the visitor resides.

As the location information for the target locations can include the general location of the target locations defined relative to a number of different regions of varying area, it will be appreciated that some regions will only include one target location and other regions will contain multiple target locations. For example, in instances in which the target locations comprise polling locations, a geo-code specifying a precinct or division will typically be unique to a respective polling location. However, geo-codes specifying a state will typically be associated with multiple polling locations.

In addition to operational information and location information, the location database can store profile information associated with the target locations. The profile information can identify characteristics of the recipients who may receive a deliverable message reciting the respective target location. In this regard, the profile information can include the same type of information as the profile information stored in the recipient database 14, as described below. The profile information can be selected in any of a number of different manners but, in one embodiment, is selected based upon the recipients more likely to frequent the particular target location. For example, the profile information for a store may comprise demographic information regarding customers who frequent a particular store.

One example of an entry for a target location in the target location database 12 might include the following: [Records N’ More, 123 Elm Street, Precinct 25, Montgomery County, State of Virginia, USA, Age 18-25]. In the foregoing database entry, “Records N’ More” is operational information comprising the name of the target location, “123 Elm Street” is the address of the target location. Also in the foregoing, “Precinct 25,” “Montgomery County,” “State of Virginia” and “USA” are geo-codes of the general location of the target location relative to regions of different area, where Precinct 25 represents one precinct within Montgomery County. Montgomery County, in turn, represents one county within the State of Virginia, which represents one state in the United States of America (USA). The entry also includes one piece of profile information, i.e., “Age 18-25,” which identifies recipients more likely to frequent the target location as those between the ages of 18 and 25. As will be appreciated, because each target location can be uniquely identified according to an address of the respective target location, the location database need not store any operational information. In this regard, the location database may only store location information relative to each target location, such as the address of the target location.

The recipient database 14 is capable of storing recipient specific information relating to the recipients, such as profile information, contact information and/or recipient location information. For example, the recipient database can store profile information related to each recipient, such as the recipient's name, age, sex, affluence, ethnicity, geographic area and/or political party. As to contact information, the recipient database can store any one or more of a number of different contact identifiers via which a message can be delivered. For example, for each recipient, contact identifiers can include an address, a wireline telephone number, a wireless telephone number, a pager number, a short message service (SMS) number, a facsimile number, an email address, a satellite radio address, a subscription cable television address and/or an instant messaging address.

Like the information stored in the location database 12, the recipient database 14 can also store recipient location information for each recipient. For example, the recipient location information can include a precise location of the recipients, such as the addresses of the recipients. Additionally, or alternatively, the location information stored by the recipient database can include more a general location of the respective recipients, such as the location of the respective recipients (or location of the respective recipients' addresses) relative to one or more particular physical regions of varying area. Also like the location information for each target location stored in the target location database, the recipient location information stored in the recipient database can include one or more geo-codes comprising the general location of the respective recipients relative to one or more regions of varying area. For example, the recipient location information can include geo-codes defining the general location of the recipient based upon the address of the recipient within a division or precinct, a county, a state and/or a country. In contrast to the location information for the target locations, all of the areas specified by the geo-codes will typically include more than one recipient. For example, in instances in a geo-code specifies a precinct or division, multiple recipients will typically have addresses within the respective polling location.

One example of a recipient database 14 entry for a recipient might include the following: [John Doe, Age 35, Male, 555-123-1234, jdoe@jdoe.com, 566 East 61st Street, Precinct 30, Montgomery County, State of Virginia, USA]. In the foregoing database entry, “John Doe,” “Age 35” and “Male” represent profile information relating to the recipient's name, age and sex, respectively. Also in the database entry, “555-123-1234” and “jdoe@jdoe.com” represent contact identifiers comprising the recipient's telephone number and email address. In addition, the database entry includes the recipient's address: “566 East 61st Street,” in addition to the following geo-codes of the general location of the recipient: “Precinct 30,” “Montgomery County,” “State of Virginia” and “USA.” As will be appreciated, as each contact identifier can uniquely identify each recipient, the recipient database need not store any profile information for any recipients, and the recipient database may only store one contact identifier (e.g., telephone number) and location information (e.g., one geo-code) for each recipient.

Advantageously, the message database 16 can store a location message relative to each of the target locations. Each location message recites the location of the respective target location, such as the address (i.e., physical address or URL) of the respective target location. In addition, each location message can recite other information relative to the respective target location, such as the operational information related to the target location (e.g., name and/or the telephone number). The location message can be in any one or more of a number of different formats as such are known. For example, the location message can be in graphical format, such as in the form of a map identifying the target location. Also, for example, the location message can be in audio format, such as in the form of a sound recording (such as in Wave format or Voice Operated Exchange (VOX) format) reciting the target location in any one of a number of languages and/or dialects. Additionally, or alternatively, the location message can be in a textual format, such as in the form of a text message.

In addition to storing the location messages, the message database 16 can store one or more action facilitating messages. Like the location messages, the action facilitating messages can be in any one or more of a number of different formats, including a graphical format, an audio format, and/or a textual format. Although the action facilitating messages are preferably in the same format as the location messages, the action facilitating messages can be in a format different from one or more of the location messages. Thus, while the location message can comprise a graphical map identifying a target location, the action facilitating messages can be in a textual format reciting the action to be performed. One of the action facilitating messages recites the action to be performed at the target locations. For example, one of the action facilitating message can recite a commercial advertisement attempting to persuade consumers to purchase a particular good or service. Also, for example, one of the action facilitating messages can recite a political advertisement from a political candidate attempting to persuade voters to vote for the candidate. Still yet, one of the action facilitating messages can comprise a notice, such as a weather notice, attempting to persuade recipients to travel to a particular location, such as a shelter.

In addition to reciting the action to be performed, one or more of the action facilitating messages can recite additional information in an attempt to persuade the recipients to perform the action. For example, one action facilitating message may recite a discount on the price of a particular good in an attempt to persuade recipients to purchase the good. Also, for example, one action facilitating message may recite a message from a celebrity or other known figure endorsing a particular political candidate in an attempt to persuade voters to vote for the political candidate.

The action facilitating messages reciting additional information can, if desired, include information specific to one or more recipients such that specific action facilitating messages can be delivered to one or more specific recipients. For example, one action facilitating message can comprise a celebrity endorsing a particular political candidate in a state-wide election, where the message is specific to voters residing within the state and/or specific to voters of a particular demographic. Also, for example, one action message can include a price discount on the purchase of a particular good, where the discount is honored at stores located in a particular geographic area. In such instances, the other action messages can be associated with location information and/or profile information, as such is described above in conjunction with the target locations.

In addition to the location database 12, the recipient database 14 and the message database 16, the system 10 also includes a processing element 18 in electrical communication with the databases. The processing element can comprise any of a number of different devices, such as a workstation, personal computer, laptop computer or other high level processor. The processing element is capable of receiving, creating or otherwise facilitating the creation of the location messages stored in the message database. In this regard, the processing element can receive location information relative to the target locations, such as the addresses (i.e., physical addresses and/or URLs) for the target locations, from the location database. Thereafter, the processing element can create the location messages in the desired format, and store the location messages in the message database. For example, the processing element can create the location messages as a sound recording utilizing voice synthesis techniques, as such are known. Alternatively, the processing element can facilitate an operator creating the location messages, such as by allowing the operator to create a sound recording reciting the locations of the target locations. The processing element can then store the sound recordings created by the operator into the message database.

In addition to creating the location messages (or receiving or facilitating creation of the location messages), the processing element 18 is capable of associating the location messages stored in the message database 16 with the recipients based upon recipient specific information stored in the recipient database 14 and the target locations (recited by respective location messages) stored in the target location database 12. For example, where the recipient database and location database comprise separate databases, the processing element can merge the recipient database including the recipient specific information with the target location database including respective target locations.

The processing element can associate the location messages with the recipients to thereby facilitating delivery of the messages to all of the recipients, as described below. However, to deliver messages to a more targeted group of recipients, the processing element can select a group of recipients based upon the profile information relating to the recipients stored in the recipient database 14. For example, the processing element can select, and thereafter deliver messages to, only those recipients affiliated with a particular political party or those recipients within a particular age group. It will be appreciated that as the processing element can limit the number of recipients to which messages are delivered, the processing element can select one or more recipients from the group of recipients at any point prior to delivering the messages, as described below.

The processing element 18 can associate each location message with one or more recipients according to any one of a number of different techniques. According to one embodiment, for example, the processing element can associate each location message with one or more recipients based upon location information, such as a distance between the location of the respective target location and the location of the recipients, as defined by the location information associated with the respective target locations and the recipients. The location messages can be associated with the recipients based upon the particular locations of each, i.e. the addresses of the target locations and the recipients. For example, from the addresses, the processing element can determine the target location to be that target location that is spaced from a respective recipient by the shortest distance and can thereafter associate the respective recipient with the location message reciting the closest target location. In a more typical embodiment, however, the location messages are associated with the recipients based upon the more general location information relative to the target locations and the recipients. More particularly, location messages reciting respective target locations can be associated with recipients by matching a geo-code of each respective target location with a geo-code of the respective recipients. Thus, reconsider the aforementioned example in which the target locations comprise polling locations and the general location information comprises precincts, with each precinct including one polling location. In such an example, each location message reciting a respective precinct can be associated with the one or more recipients that reside within the respective precinct, as determined by the general location information of the respective recipients identifying the same precinct.

It will be appreciated that, as the geo-codes comprise a more general location of a target location or recipient defined according to regions of varying area, any one or more recipients can have one or more geo-codes that match one or more geo-codes of one or more target locations. Thus, for example, a recipient can include a geo-code defining the same state as defined in the geo-codes of multiple target locations, including all target locations within the same state. In such instances, the recipients can be associated with all target locations that have a geo-code matching the geo-code of the respective recipients. More typically, however, the recipients are associated with only one target location (although each target location can be associated with multiple recipients). Such a target location can be associated with respective recipients by matching a predefined geo-code of the recipients with a geo-code of a target location such that each recipient is associated with only one target location. The predefined geo-code of each recipient can then be selected to be the geo-code defined by the region having the smallest area. If the geo-code of the recipient that is defined by the region having the smallest area does not match any geo-code of any target location, however, the recipient can be associated with the location message reciting the target location otherwise located the shortest distance from the recipient, such as can be determined according to the addresses of the target locations and the recipient.

In addition to, or in lieu of, associating location messages with recipients based upon location information, the processing element 18 can associate the location messages with recipients based upon the profile information associated with respective target locations and the profile information associated with the recipients, particularly when the target locations comprise online locations. In this regard, the processing element can determine the target location to be that target location that has at least one piece of profile information matching at least one piece of profile information associated with a respective recipient. For example, the processing element can determine the target location to be the target location including a piece of profile information defining a range of ages (e.g., 18-35) that includes the age of a respective recipient (e.g., 35). In such an example, each location message reciting a target location associated with profile information defining a respective range of ages can be associated with the one or more recipients that have an age within the range of ages, as determined by the piece of profile information associated with the respective recipients identifying the age of the respective recipients.

As before with associating location messages with recipients based upon location information, it will be appreciated that any one or more recipients can have one or more pieces of profile information that match one or more pieces of profile information of one or more target locations. Thus, for example, a recipient can include profile information including the age of the recipient that is within age ranges of profile information associated with multiple target locations. In such instances, the recipients can be associated with all target locations that have at least one piece of profile information matching at least one piece of profile information of the respective recipients. More typically, however, the recipients are associated with only one target location (although each target location can be associated with multiple recipients). Such a target location can be associated with respective recipients by matching a predefined piece of profile information of the recipients with a piece of profile information of the target location such that each recipient is associated with only one target location. Alternatively, such a target location can be associated with respective recipients by matching a predefined piece of profile information of the target location with a piece of profile information of the recipients so that no two target locations are associated with the same recipient, such as by selecting a number of target locations none of which include the same predefined piece of profile information.

As indicated above, one or more action facilitating messages reciting additional information (i.e., information other than the action to be performed) can, if desired, include information specific to one or more recipients. In such instances, the action facilitating messages can be associated with location information and/or profile information. As such, the action facilitating messages including location information and/or profile information can also be associated with recipients in a manner similar to the location messages, as described above. With the location messages, and possibly one or more action facilitating messages, associated with the recipients, the processing element 18 can create a deliverable message based upon each location message and the action facilitating messages stored in the message database 16. In this regard, the processing element can create each deliverable message by combining or otherwise merging the action facilitating message reciting the action to be performed with a respective location message. Each deliverable message, then, recites the action to be performed and thereafter a respective location at which to perform the action. For example, a deliverable message may recite a vote solicitation from a political candidate followed by a polling location where respective recipients may vote for the particular political candidate. Additionally, if one or more action facilitating messages reciting additional information are associated with respective location messages, the processing element can create the respective deliverable messages by additionally combining or merging such action facilitating messages with the action facilitating message reciting the action to be performed and respective location messages. For example, a deliverable message may recite a vote solicitation from a particular political candidate, followed by an endorsement of the candidate from a celebrity, followed by the polling location where respective recipients may vote for the particular political candidate.

Like the location messages and action facilitating message, the deliverable messages can be in any one or more of a number of different formats, including a graphical format, an audio format, and/or a textual format. Preferably, the deliverable message is in the format(s) of the action facilitating message and the respective location message and, as such, the deliverable message can be in one or more formats. For example, where the location message comprises a graphical map identifying a target location and the action facilitating message comprises a textual message, the respective deliverable message preferably comprises a message having a graphical portion and a textual portion.

After creating the deliverable messages, the processing element 18 can deliver the deliverable messages to the recipients to thereby facilitate the recipients performing the action at respective target locations. Prior to delivering the deliverable messages, however, the processing element can, but need not, store the deliverable messages, such as in the message database 16. The deliverable messages can be stored along with the location messages or, alternatively, the deliverable messages can replace the respective location messages within the message database. In embodiments where the deliverable messages are not stored, the processing element preferably delivers the deliverable messages to respective recipients immediately after creating the respective deliverable messages. In contrast, in embodiments where the deliverable messages are stored, the processing element can deliver the deliverable messages immediately after the respective deliverable messages are created or at any time thereafter.

The processing element 18 can deliver the deliverable messages to the recipients based upon the contact identifiers associated with the respective recipients. As stated above, the recipient database 14 can store any one or more of a number of different contact identifiers for each recipient. For example, a contact identifier can include an address, a wireline telephone number, a wireless telephone number, a pager number, an SMS number, a facsimile number, an email address, a satellite radio address, a subscription cable television address and/or an instant messaging address. The deliverable messages can therefore be delivered to the recipients in any one or more of a number of different manners. For example, the deliverable message can be delivered via mail, a wireline telephone, a wireless telephone (using a wireless telephone number and/or an SMS number), a pager, a personal digital assistant (PDA), a facsimile machine, email, a radio receiving a satellite radio reception, a television receiving a subscription television service and/or an instant message.

Prior to delivering the deliverable messages, if necessary, the processing element 18 can package each deliverable message in accordance with the method by which the processing element is to deliver the deliverable messages, such are known. For example, if one or more deliverable messages are to be delivered to recipients via email, the processing element preferably packages the deliverable messages for delivery via email, such as according to the Simple Mail Transfer Protocol (SMTP). Also, for example, if one or more deliverable messages are to be delivered to recipients via mail, the processing element preferably packages the deliverable messages in preparation to print the deliverable messages such that the deliverable messages can be mailed to respective recipients at the recipients' addresses.

After packaging each deliverable message (if necessary), the processing element 18 can deliver the deliverable messages to the recipients based upon the contact identifiers associated with the recipients that are, in turn, associated with respective deliverable messages. The deliverable messages can be delivered in any of a number of different manners but, in one embodiment, the deliverable messages are delivered over one or more networks 20 associated with the respective formats of the deliverable messages. For example, deliverable messages delivered via an email are preferably delivered to an email address of the recipient over a network such as a wide area network (WAN) like the Internet. Also, for example, messages delivered via a landline telephone are preferably delivered to the recipient, via the recipient's telephone number, over a network such as a public switched telephone network (PSTN). If the deliverable messages are to be delivered to recipients via mail, however, the processing element can prepare the deliverable messages for delivery, as stated above, such that a mail carrier can deliver the deliverable messages.

Upon delivery of the deliverable messages from the processing element 18, the recipients can receive the deliverable messages, and thereafter view, listen to and/or read respective deliverable messages to thereby facilitate the recipients performing the action at respective target locations. In this regard, the recipients may receive the deliverable messages at devices configured to receive messages delivered based upon respective contact identifiers. For example, if one or more deliverable messages are delivered according to wireless telephone numbers or SMS numbers, the recipients can receive the deliverable messages via wireless telephones 22. Also, for example, if one or more deliverable messages are delivered to email addresses (and possibly facsimile numbers), the recipients can receive the deliverable messages via a client processing element 24, such as a workstation, personal computer, laptop computer or the like. In contrast, if one or more deliverable messages are delivered according to landline telephone numbers, the recipients can receive the deliverable messages via a landline telephone 26. Further, for example, if one or more deliverable messages are delivered according to satellite radio addresses or subscription cable television addresses, the recipients can receive the deliverable messages via a radio 27 receiving a satellite radio reception or a television 29 receiving a subscription television service, respectively.

Before, after and/or during delivery of the deliverable messages, the processing element 18 can additionally gather data regarding the deliverable messages and delivery of such messages. The processing element can gather any of a number of different data regarding the deliverable messages, including the number of deliverable messages that the processing element attempted to deliver, the number that the processing element successfully delivered, and/or the number of deliverable messages that were completely or partially viewed, heard and/or read by respective recipients. For example, when the deliverable messages comprise deliverable sound recordings delivered by the processing element via landline or wireline telephones, the processing element can gather data regarding the following: total calls made, number of calls receiving a busy signal, number of calls for which the person answering the telephone hung up, the number of sound recordings completely delivered to a person and/or an answering machine, the number of calls that were not answered, and the number of calls in which the telephone number was no longer in service, the receiving line telephone circuit was busy or the telephone call otherwise did not go through to the desired telephone.

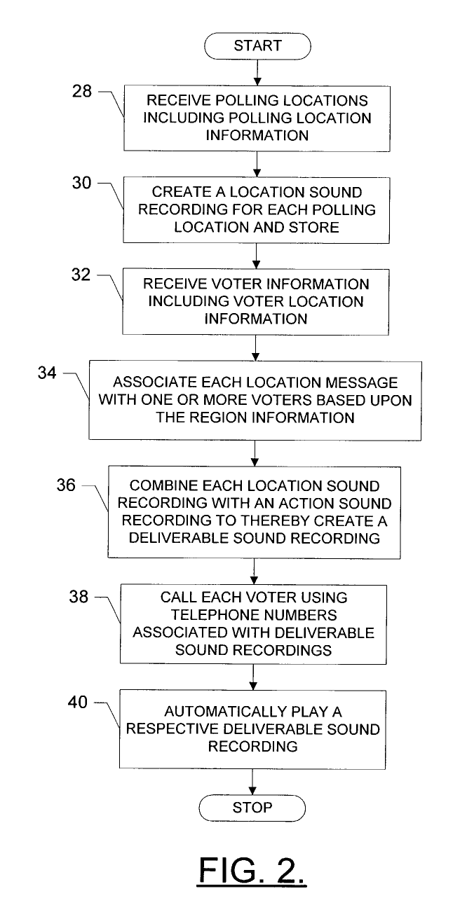

Reference will now be drawn to FIG. 2, which illustrates one method of operation of the system 10 in accordance with one embodiment of the present invention. In the scenario illustrated in FIG. 2, the recipients comprise voters in an upcoming election, and the target locations represent polling locations in precincts within a county. According to the following scenario, then, the action facilitating message can comprise an advertisement of a political candidate attempting to persuade the voters to vote for the political candidate in the election. It should be understood, however, that the embodiment illustrated in FIG. 2 is only one of a number of different embodiments of the present invention and, therefore, should not be seen to limit of the present invention.

To begin operation, the processing element 18 receives location information relative to the polling locations, including the addresses and geo-codes, as shown in block 28. Thereafter, the processing element creates and stores the location messages in the desired format, shown in block 30 as location sound recordings. Upon creating the location sound recordings, the processing element receives the voter information including voter location information (e.g., geo-codes) and contact identifiers comprising telephone numbers, as illustrated in block 32. As shown in block 34, the processing element then associates the location sound recordings with respective recipients and, thus, respective telephone numbers, by matching a geo-code of each polling location with the geo-code of one or more recipients. For example, as the target locations comprise polling locations within different precincts (i.e., one of the geo-codes of each polling location indicates a different precinct), the location sound recording for the polling location in each precinct is associated with the telephone numbers of voters residing within the respective precinct (i.e., one of the geo-codes of each voter residing within the respective precinct includes the respective precinct).

With the location sound recordings associated with the telephone numbers, the processing element 18 creates deliverable sound recordings by combining or otherwise merging each location sound recording and the action facilitating sound recording, where the action facilitating sound recording recites a message from the political candidate attempting to persuade the voters to vote for the candidate, as shown in block 36. Each deliverable sound recording, then, recites the message from the candidate and thereafter recites the polling location in the precinct in which the voter lives (or otherwise the closest polling location if no polling location exists in the precinct in which the voter lives). After creating the deliverable messages, the processing element calls the voters landline telephones 26 using the telephone numbers, as shown in block 38. Thereafter, the processing element automatically plays the deliverable sound recordings for the respective recipients to thereby facilitate the recipients voting for the candidate at the respective polling locations, as shown in block 40.

Embodiments of the present invention are therefore capable of providing messages to targeted recipients based upon information relative to the recipients. In this regard, the embodiments of the present invention are capable of providing the advantages of conventional targeted advertising. In contrast to conventional targeted advertising, however, embodiments of the present invention further facilitate performance of an action (e.g., voting) by providing a target location at which the recipient can perform the action (e.g., polling location). As such, embodiments of the present invention are capable of facilitating recipients performing the action, where the recipients are persuaded by the message to perform the action but otherwise do not know of a convenient location to perform the action.

The methods of the present invention can generally be implemented by one or more computer processing elements, such as microprocessors or the like. For example, all or a portion of the methods can be performed by the processing element 18. The computer processing elements typically operate under the control of a computer program product. The computer program product includes a computer-readable storage medium, such as a non-volatile storage medium, and computer-readable program code portions, such as a series of computer instructions, embodied in the computer-readable storage medium. Typically, the computer program product is stored by the computer processing element or a related memory device.

In this regard, FIG. 2 is a block diagrams and control flow illustration of methods, systems and program products according to the invention. It will be understood that each block or step of the block diagram, flowchart and control flow illustration, and combinations of blocks in the block diagram, flowchart and control flow illustration, can be implemented by computer program instructions. These computer program instructions may be loaded onto a computer or other programmable apparatus to produce a machine, such that the instructions which execute on the computer or other programmable apparatus create means for implementing the functions specified in the block diagram, flowchart or control flow block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the block diagram, flowchart or control flow block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block diagram, flowchart or control flow block(s) or step(s).

Accordingly, blocks or steps of the block diagram or control flow illustration support combinations of means for performing the specified functions, combinations of steps for performing the specified functions and program instruction means for performing the specified functions. It will also be understood that each block or step of the block diagram, flowchart or control flow illustration, and combinations of blocks or steps in the block diagram, flowchart or control flow illustration, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of facilitating performance of an action at at least one target location, said method comprising:
providing at least one location message reciting the at least one target location;
associating each location message with at least one recipient based upon recipient specific information and the target location recited by the respective location message;
creating at least one deliverable message based upon the at least one location message and at least one action facilitating message, wherein the at least one action facilitating message recites the action to be performed, and wherein the at least one deliverable message is associated with the at least one recipient associated with the at least one location message; and
delivering the at least one deliverable message to the respective at least one recipient thereby facilitate the at least one recipient performing the action at the at least one target location.

2. A method according to claim 1, wherein providing at least one location message comprises providing at least one target location and thereafter creating the at least one location message based upon the at least one target location.

3. A method according to claim 1, wherein associating the at least one location message comprises associating the at least one location message with at least one recipient based upon at least one recipient specific telephone number and the at least one target location, and wherein delivering the at least one deliverable message comprises calling each recipient based upon a respective telephone number and thereafter delivering the respective at least one deliverable message.

4. A method according to claim 1, wherein the recipient specific information identifies at least one recipient at at least one recipient location, and wherein associating each location message comprises associating each location message with at least one recipient based upon the target location recited by the respective location message and the at least one recipient location.

5. A method according to claim 1, wherein the method facilitates performance of the action at one of a plurality of target locations, wherein providing at least one location message comprises providing a plurality of location messages each reciting a different target location, wherein associating each location message comprises associating each of the plurality of location messages with at least one recipient, wherein creating at least one deliverable message comprises creating a plurality of deliverable messages based upon the plurality of location messages and at least one action facilitating message, and wherein delivering the at least one deliverable message comprises delivering each of the plurality of deliverable messages to at least one recipient based upon the at least one recipient associated with the respective deliverable message.

6. A method according to claim 1, wherein providing at least one location message comprises providing at least one location sound recording, wherein associating the at least one location message comprises associating the at least one location sound recording with at least one recipient based upon at least one recipient specific telephone number and the at least one target location, wherein the at least one action facilitating message comprises at least one action facilitating sound recording, wherein creating at least one deliverable message comprises combining the at least one location sound recording and the at least one action facilitating sound recording into at least one deliverable sound recording, and wherein delivering the at least one deliverable message comprises calling each recipient based upon a respective telephone number and thereafter playing a respective deliverable sound recording.

7. A method according to claim 1 further comprising selecting at least one recipient from a group of recipients, wherein associating each location message comprises associating each location message with the selected at least one recipient, and wherein delivering the at least one deliverable message comprises delivering the at least one deliverable message to the respective selected at least one recipient.

8. A method according to claim 1 further comprising gathering data regarding delivery of the at least one deliverable message, wherein gathering data occurs at least one of before delivery of the at least one deliverable message, during delivery of the at least one deliverable message and after delivery of the at least one deliverable message.

9. A method according to claim 1, wherein at least one action facilitating message recites additional information, said method further comprising associating the at least one action facilitating message reciting additional information with at least one recipient based upon recipient specific information, wherein creating at least one deliverable message comprises creating at least one deliverable message based upon the at least one location message, the at least one action facilitating message reciting the action to be performed and the at least one action facilitating message reciting additional information.

10. A system for facilitating performance of an action at at least one target location, said system comprising:
a processing element capable of receiving at least one location message reciting the at least one target location, wherein said processing element is capable of associating each location message with at least one recipient based upon recipient specific information and the target location recited by the respective location message, wherein said processing element is further capable of creating at least one deliverable message based upon the at least one location message and at least one action facilitating message, wherein the at least one action facilitating message recites the action to be performed, and wherein the at least one deliverable message is associated with the at least one recipient associated with the at least one location message, and wherein said processing element is capable of delivering the at least one deliverable message to the respective at least one recipient to thereby facilitate the at least one recipient performing the action at the at least one target location; and
at least one database in electrical communication with said processing element, wherein said at least one database is capable of storing at least one of the at least one location message, the recipient specific information, the at least one deliverable message, and the action facilitating message.

11. A system according to claim 10, wherein said processing element is further capable of receiving the at least one target location and thereafter creating the at least one location message based upon the at least one target location.

12. A system according to claim 10, wherein the recipient specific information includes at least one recipient specific telephone number, and wherein said processing element is capable of delivering the at least one deliverable message by calling each recipient based upon a respective telephone number and thereafter delivering a respective deliverable message.

13. A system according to claim 10, wherein the recipient specific information identifies at least one recipient at at least one recipient location, and wherein said processing element is capable of associating each location message with at least one recipient based upon the target location recited by the respective location message and the at least one recipient location.

14. A system according to claim 10, wherein the system facilitates performance of the action at one of a plurality of target locations, wherein said processing element is capable of receiving a plurality of location messages each reciting a different target location, wherein said processing element is capable of associating each of the plurality of location messages with at least one recipient, wherein each location message recites a different target location, wherein said processing element is capable of creating a plurality of deliverable messages based upon the plurality of location messages and at least one action facilitating message, and wherein said processing element is capable of delivering each of the plurality of deliverable messages to at least one recipient based upon the at least one recipient associated with the respective deliverable message.

15. A system according to claim 10, wherein the at least one location message comprises at least one location sound recording, wherein the recipient specific information includes at least one recipient specific telephone number, wherein the at least one action facilitating message comprises at least one action facilitating sound recording, wherein said processing element is capable of creating at least one deliverable message by combining the at least one location sound recording and the at least one action facilitating sound recording into at least one deliverable sound recording, and wherein said processing element is capable of delivering the at least one deliverable sound recording by calling each recipient based upon a respective telephone number and thereafter playing a respective deliverable sound recording.

16. A system according to claim 10, wherein said processing element is further capable of selecting at least one recipient from a group of recipients, wherein said processing element is capable of associating each location message the selected at least one recipient, and wherein said processing element is capable of delivering the at least one deliverable message to the respective selected at least one recipient.

17. A system according to claim 10, wherein the system facilitates voting at at least one polling location, wherein the at least one location message recites the at least one polling location, wherein the at least one recipient comprises at least one voter capable of voting at at least one of the polling locations, and wherein the at least one action facilitating message recites a vote solicitation.

18. A system according to claim 10, wherein said processing element is further capable of gathering data regarding delivery of the at least one deliverable message, wherein said processing element is capable of gathering the data at least one of before delivery of the at least one deliverable message, during delivery of the at least one deliverable message and after delivery of the at least one deliverable message.

19. A system according to claim 10, wherein at least one action facilitating message recites additional information, wherein said processing element is further capable of associating the at least one action facilitating message reciting additional information with at least one recipient based upon recipient specific information, and wherein said processing element is capable of creating at least one deliverable message based upon the at least one location message, the at least one action facilitating message reciting the action to be performed and the at least one action facilitating message reciting additional information.

20. A computer program product for facilitating performance of an action at at least one target location, the computer program product comprising a computer-readable storage medium having computer-readable program code portions stored therein, the computer-readable program code portions comprising:
a first executable portion for receiving at least one location message reciting the at least one target location;
a second executable portion for associating each location message with at least one recipient based upon recipient specific information and the target location recited by the respective location message;
a third executable portion for creating at least one deliverable message based upon the at least one location message and at least one action facilitating message, wherein the at least one action facilitating message recites the action to be performed, and wherein the at least one deliverable message is associated with the at least one recipient associated with the at least one location message; and
a fourth executable portion for delivering the at least one deliverable message to the respective at least one recipient to thereby facilitate the at least one recipient performing the action at the at least one target location.

21. A computer program product according to claim 20, wherein said first executable portion receives the at least one location message by receiving at least one target location and thereafter creating the at least one location message based upon the at least one target location.

22. A computer program product according to claim 20, wherein said second executable portion associates the at least one location message by associating the at least one location message with at least one recipient based upon at least one recipient specific telephone number and the at least one target location, and wherein said fourth executable portion delivers the at least one deliverable message by calling each recipient based upon a respective telephone number and thereafter delivering the respective at least one deliverable message.

23. A computer program product according to claim 20, wherein the recipient specific information identifies at least one recipient at at least one recipient location, and wherein said second executable portion associates each location message by associating the at least one location message with at least one recipient based upon the target location recited by the respective location message and the at least one recipient location.

24. A computer program product according to claim 20, wherein the computer program product facilitates performance of the action at one of a plurality of target locations, wherein said first executable portion receives a plurality of location messages each reciting a different target location, wherein said second executable portion associates each location message by associating each of the plurality of location messages with at least one recipient, wherein said third executable portion creates at least one deliverable message by creating a plurality of deliverable messages based upon the plurality of location messages and at least one action facilitating message, and wherein said fourth executable portion delivers the at least one deliverable message by delivering each of the plurality of deliverable messages to at least one recipient based upon the at least one recipient associated with the respective deliverable message.

25. A computer program product according to claim 20, wherein said first executable portion receives at least one location sound recording, wherein said second executable portion associates the at least one location message by associating the at least one location sound recording with at least one recipient based upon at least one recipient specific telephone number and the at least one target location, wherein the at least one action facilitating message comprises at least one action facilitating sound recording, wherein said third executable portion creates at least one deliverable message by combining the at least one location sound recording and the at least one action facilitating sound recording into at least one deliverable sound recording, and wherein said fourth executable portion delivers the at least one deliverable message by calling each recipient based upon a respective telephone number and thereafter playing a respective deliverable sound recording.

26. A computer program product according to claim 20 further comprising a fifth executable portion capable of selecting at least one recipient from a group of recipients, wherein said second executable portion associates each location message by associating each location message with the selected at least one recipient, and wherein said fourth executable portion delivers the at least one deliverable message by delivering the at least one deliverable message to the respective selected at least one recipient.

27. A computer program product according to claim 20 further comprising a fifth executable portion capable of gathering data regarding delivery of the at least one deliverable message, wherein said fifth executable portion gathers data at least one of before said fourth executable portion delivers the at least one deliverable message, as said fourth executable portion delivers the at least one deliverable message and after said fourth executable portion delivers the at least one deliverable message.

28. A computer program product according to claim 20, wherein at least one action facilitating message recites additional information, wherein said second executable portion is further capable of associating the at least one action facilitating message reciting additional information with at least one recipient based upon recipient specific information, and wherein said third executable portion is capable of creating at least one deliverable message by creating at least one deliverable message based upon the at least one location message, the at least one action facilitating message reciting the action to be performed and the at least one action facilitating message reciting additional information.

29. A method of facilitating voting at at least one polling location, said method comprising:
providing at least one location message reciting the at least one polling location for voting;
associating each location message with at least one voter based upon voter specific information and the polling location recited by the respective location message;
creating at least one deliverable message based upon the at least one location message and at least one action facilitating message, wherein the at least one action facilitating message recites a solicitation to vote at the at least one polling location, and wherein the at least one deliverable message is associated with the at least one voter associated with the at least one location message; and
delivering the at least one deliverable message to the respective at least one voter to thereby facilitate the at least one voter voting at the at least one polling location.

30. A method according to claim 29, wherein providing at least one location message comprises providing at least one polling location and thereafter creating the at least one location message based upon the at least one polling location.

31. A method according to claim 29, wherein associating the at least one location message comprises associating the at least one location message with at least one recipient based upon at least one recipient specific telephone number and the at least one location, and wherein delivering the at least one deliverable message comprises calling each voter based upon a respective telephone number and thereafter delivering the respective at least one deliverable message.

32. A method according to claim 29, wherein the recipient specific information identifies at least one voter at at least one voter location, and wherein associating each location message comprises associating each location message with at least one recipient based upon the polling location recited by the respective location message and the at least one voter location.

33. A method according to claim 29, wherein the method voting at one of plurality of polling locations, wherein providing at least one location message comprises providing a plurality of location messages each reciting a different polling location, wherein associating each location message comprises associating each of the plurality of location messages with at least one recipient, wherein creating at least one deliverable message comprises creating a plurality of deliverable messages based upon the plurality of location messages and at least one action facilitating message, and wherein delivering the at least one deliverable message comprises delivering each of the plurality of deliverable messages to at least one voter based upon the at least one recipient associated with the respective deliverable message.

34. A method according to claim 29, wherein providing at least one location message comprises providing at least one location sound recording, wherein associating the at least one location message comprises associating the at least one location sound recording with at least one recipient based upon at least one recipient specific telephone number and the at least one polling location, wherein the at least one action facilitating message comprises at least one action facilitating sound recording reciting a vote solicitation, wherein creating at least one deliverable message comprises combining the at least one location sound recording and the at least one action facilitating sound recording into at least one deliverable sound recording, and wherein delivering the at least one deliverable message comprises calling each voter based upon a respective telephone number and thereafter playing a respective deliverable sound recording.

35. A method according to claim 29 further comprising selecting at least one voter from a group of voters, wherein associating each location message comprises associating each location message with the selected at least one voter, and wherein delivering the at least one deliverable message comprises delivering the at least one deliverable message to the respective selected at least one voter.

36. A method according to claim 29 further comprising gathering data regarding delivery of the at least one deliverable message, wherein gathering data occurs at least one of before delivery of the at least one deliverable message, during delivery of the at least one deliverable message and after delivery of the at least one deliverable message.

37. A method according to claim 29, wherein at least one action facilitating message recites additional information, said method further comprising associating the at least one action facilitating message reciting additional information with at least one voter based upon voter specific information, wherein creating at least one deliverable message comprises creating at least one deliverable message based upon the at least one location message, the at least one action facilitating message reciting the solicitation to vote at the at least one polling location and the at least one action facilitating message reciting additional information.
